(19) United States
(12) Patent Application Publication
(10) Pub. No.: US 2007/0260465 A1
(43) Pub. Date: Nov. 8, 2007

(54) Wireless Electronic Real Estate Resource System

(76) Inventor: Richard A. Cook, San Diego, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/381,573

(22) Filed: May 4, 2006

(51) Int. Cl. G06Q 10/00; G06Q 30/00

(52) U.S. Cl. 705/1

(57) ABSTRACT

An improved system and method of advertising and collection of information relating to real property is provided. The present invention is a wireless communication device and/or box that is placed within the residence or structure on the property that transmits a signal relating to characteristics and information relating to that property along with links to other featured property, information relating to the agent, seller and other desired information. The invention may allow a potential buyer that is outside of the building to access photographs, take a tour, and gather information relating to the property. Additionally, a system and a method is provided whereby the potential buyer may leave feedback information or contact information such that the realtor, agent or owner may contact the potential buyer back. Moreover, the invention may allow for a tracking of traffic relating to the access of the wireless connection and give feedback to the agent, realtor relating to how many potential buyers accessed the connection, times the device was accessed and any other pertinent information to facilitate easier sale of the property.

### BACKGROUND OF THE INVENTION

1. Field of the Invention

This invention relates generally to field of real estate technology, more specifically to a wireless electronic system to facilitate marketing and dissemination of information relating to real estate property to potential buyers and to the real estate agent.

2. Description of the Prior Art

The history of real estate dates back as early as time. People have always wanted a good way to leave the residence they lived in to either upgrade or move to another location. However, the innovation of hiring a real estate agent and listing your property for others to see came much later.

The current method of marketing real estate property for sale is labor intensive and necessarily results in significant variation in quality and timeliness of information transfer between the property seller, the seller's agent and the prospective buyers. Historically, many real estate advertising methods were simple such as putting a sign in front of the property to tell potential buyers that the property was for sale. These methods of selling real estate do not involve formal and substantive real estate involvement. While this might be advantageous for some, it can lead to confusion, significant lost time and energy to facilitate a sale.

Traditional real estate signs serve only to direct prospective buyers to a single real estate office or agent. The properties can only be inspected and viewed during specific “open house” times and when an appointment is made with the real estate agent, or owner of the residence. These appointments must be scheduled ahead of time and only after the property has been located by the buyer. This is quite problematic in that where the properties are occupied or far from a prospective buyer, it causes an undue burden on the buyer to find the appropriate property for their needs.

Additionally, another potential problem is that the buyer has limited access and does not always feel at ease with an agent alongside. Some buyers would prefer the ease of looking and searching for an appropriate property at their own convenience and on their own time. This is problematic if an agent or owner is needed in order to view the property or inspect the grounds.

Further, property visits are documented only by agents leaving their business cards and visit durations are usually undeterminable. Such information may materially assist in achieving a rapid sale satisfactory to all parties. Since interactions between the seller and potential buyer are traditionally discouraged, potential buyer comments, impressions and opinions are typically never relayed to the seller such that the seller may make improvements to the property to make it more attractive to prospective buyers. Additionally, there is no record of how many prospective buyers come to, and inspect the house. (ie—how much foot traffic there is) Therefore, there is no effective way of tracking the traffic through the house and the amount of actual interest there may be in a particular piece of property.

Another problematic issue facing the real estate market is the collection of information concerning a particular piece of property. Many times, an agent or owner would like to update the property, to include information relating to offers made, status of the property, scheduled showings of the property and open houses. However, until now, the agent or owner has not had a good way of illustrating this information.

In addition to these limitations of the current real estate business model, the security of a property listed for sale is often compromised by the placement of a mechanical real estate lock box on one or more points of access on the property. Such prior art lock boxes operate via a common physical key or spin dial combination distributed to many agents and boxes are reused among properties offered for sale. Such factors compromise the security of the real estate property.

Moreover, there are times while driving through a neighborhood when a prospective home buyer finds a home or property that is of interest, but there is little or no information available about the property at that particular moment. One option for the prospective buyer is to call the real estate agent advertising the property to obtain more information. If the agent is unavailable, the buyer must leave a message and wait for a return telephone call. If a sales agent accompanies the buyer, the sales agent may have a Multiple Listing Service (MLS) description, but the listing may not be current if its in printed form or is an earlier download of an electronic form.

In the case where the buyers are relocating, or the buyers are trying to buy the property on a very short timeline, having a minimal amount of information relating to the property can be crucial. With the necessary information available to the buyer, hey can decide whether to continue pursuing a particular parcel of realty or move on to another location. In this example, the seller loses a valuable opportunity to make a strong initial impression if the property information is not easily and immediately available to the buyer.

In another example, a prospective buyer may be driving around a neighborhood and see several houses for sale. However, in order to gain additional information relating to the house, the buyer must contact the realtor, agent and schedule a viewing. A prospective buyer might have to do this multiple times while looking for an appropriate piece of property to buy. Additionally, the buyer may not be able to leave feedback or check and see what other properties are available for sale in the same neighborhood.

Thus a need therefore exists for an improved system for real estate advertising and dissemination of property information. The present invention satisfies this need and provides related advantages as well.

### SUMMARY OF THE INVENTION

The present invention provides an improved system and method of advertising and collection of information relating to real property. The present invention is a wireless communication device and/or box that is placed within the residence or structure on the property that transmits a signal relating to characteristics and information relating to that property along with links to other featured properties, information relating to the agents seller and other desired information. The invention may allow a potential buyer that is outside of the building to access photographs, take an interior tour, and gather information relating to the property. Additionally, the invention has a system and a method whereby the potential buyer may leave feedback information or contact information such that the realtor, agent or owner may contact the potential buyer back. Moreover, the invention may allow for a tracking of traffic relating to the access of the wireless connection and give feedback to the agent, realtor relating to how many potential buyers accessed the connection, times the device was accessed and any other pertinent information to facilitate easier sale of the property.

To this end, in an embodiment of the present invention, a real estate resource system is provided. The system has a real estate sign corresponding to a property wherein the real estate sign displays that the property has a wireless communication system thereon. Moreover, the system has a wireless electronic device having property information contained thereon and further wherein the device being contained within a structure on the property.

In an embodiment, the real estate resource system has a wireless electronic device that transmits a signal to a potential buyer's wireless capable electronic device.

In an embodiment, the real estate resource system has a wireless electronic device that transmits information relating to the property including photographs and virtual tours of the property.

In an embodiment, the real estate resource system has a wireless electronic device that transmits information relating to the property including information about the agent and other properties available for sale.

In an embodiment, a real estate resource system has a wireless electronic device that further comprises a processor and a memory storage unit.

In an embodiment, a real estate resource system has a wireless electronic device that further comprises a power source, wireless networking capability and a Global Positioning system.

In an embodiment, a real estate resource system may allow information to be stored and removed from the wireless electronic device when desired.

In an embodiment, a real estate resource system is provided wherein a potential buyer may leave feedback information that is inputted into the memory storage unit of the wireless electronic device.

In an embodiment, a real estate resource system is provided wherein the wireless electronic device notifies an owner or agent of potential buyers of the property if feedback information is left by the potential buyer with the wireless electronic device.

In an embodiment, a real estate resource system is provided wherein the wireless electronic device transmits a property specific web page that cannot be utilized for any other purpose other than the transmittal of that specific property or linked properties contained within the memory of the wireless electronic device.

In an embodiment of the present invention, a method for using a using a real estate resource system is provided. The method comprising the steps of: providing a real estate sign corresponding to a property wherein the real estate sign displays that the property has a wireless communication system thereon; providing a wireless electronic device having property information contained thereon wherein the device is contained within a structure on the property; inputting information into the wireless electronic device relating to the property for transmission to potential purchasers.

In an embodiment, the method farther comprises the step of: providing the wireless electronic device with wireless networking capability.

In an embodiment, the method further comprises the step of: providing the wireless electronic device with a processor and memory storage capabilities.

In an embodiment, the method further comprises the step of: providing the wireless electronic device with a power source and Global positioning capabilities.

In an embodiment, the method further comprises the step of: allowing the wireless electronic device to transmit a web-based property specific web page to a potential buyer.

In an embodiment, the method farther comprises the step of: allowing a potential purchaser with a wireless capable device to receive a transmission from the wireless electronic device located on the property.

In an embodiment, the method further comprises the step of: prompting the potential purchaser to leave feedback relating to the property.

In an embodiment, the method further comprises the step of: prompting the potential purchaser to request a showing of the property or to contact the agent or owner of the property.

In an embodiment, the method further comprises the step of: transmitting the contact information of a potential purchaser to the agent or owner such that the agent or owner can contact the potential purchaser to provide additional information or schedule a viewing of the property.

In an embodiment, the method further comprises the step of: allowing for the wireless electronic device to be removed from the property and the information on the memory of the device to be removed and replaced with new information relating to a new property.

It is, therefore, an advantage of the present invention to provide a unique system and method for communication of real estate property.

Another exemplary embodiment of the present invention is to provide a unique system and method for communication of real estate property using a proprietary hardware design.

Still another exemplary embodiment of the present invention is to provide a unique system and method for communication of real estate property whereby the system may utilize proprietary hardware that may be placed inside the property structure and more preferably be placed inside the house located on the property.

Yet another exemplary embodiment of the present invention is to provide a unique system and method for communication of real estate property that may allow for a potential buyer to receive information from a proprietary device located on the property.

Still another exemplary embodiment of the present invention is to provide a unique system and method for communication of real estate property that may allow for dissemination of information relating to the property to prospective buyers that may be passing by the property.

Another exemplary embodiment of the present invention is to provide a unique system and method for communication of real estate property that may be used a proprietary device located within a structure on the property that may provide a wireless signal to any potential buyers that are located within a certain range of the proprietary device.

Another exemplary embodiment of the present invention is to provide a unique system and method for communication of real estate property wherein the system may be employed by an agent in a singular property to promote multiple different properties.

An exemplary embodiment of the present invention is to provide a unique system and method for communication of real estate property wherein the system may use a wireless device to communicate information relating to the property to potential buyers.

Still another exemplary embodiment of the present invention is to provide a unique system and method for communication of real estate property wherein the system employs a wireless device to communicate information relating to the property to potential buyers wherein the device sends a wireless signal that broadcasts only the information relating to the real estate and other relevant information about the same.

Yet another exemplary embodiment of the present invention is to provide a unique system and method for communication of real estate property wherein the system may use a proprietary device wherein the device uses a wireless signal to broadcast information to a wireless device used by a potential buyer.

Yet another exemplary embodiment of the present invention is to provide a unique system and method for communication of real estate property wherein the system may have a proprietary device wherein the device uses a wireless signal to broadcast pictures, tours of the houses contact information and a plurality of additional information to a potential buyer.

Another exemplary embodiment of the present invention is to provide a unique system and method for communication of real estate property wherein the system may allow for feedback to be recorded by a proprietary device located within the property.

Still another exemplary embodiment of the present invention is to provide a unique system and method for communication of real estate property wherein the system may employ a device for storing information relating to the property.

Another exemplary embodiment of the present invention is to provide a unique system and method for communication of real estate property wherein a proprietary device may be configured by a real estate owner with information relating to the property and other properties listed by the same agent.

Yet another exemplary embodiment of the present invention is to provide a unique system and method for communication of real estate property wherein a proprietary device may be configured by a real estate owner or agent with information relating to the property and may give buyers other properties in the same area that are for sale that they may view from outside of the property without the need to make an appointment with the agent or owner to view.

Still another exemplary embodiment of the present invention is to provide a unique system and method for communication of real estate property wherein a proprietary device may be configured by a real estate owner or agent with information relating to the property including a tour, pictures, pricing and other features relating to same.

An exemplary embodiment of the present invention is to provide a unique system and method for communication of real estate property wherein a proprietary device may be configured by a real estate owner or agent to allow transmittal of information relating to the property to be received and reviewed by a wireless device outside of the property and further wherein the signal transmitted by the proprietary device is dedicated and only provides information relating to the property.

Yet another exemplary embodiment of the present invention is to provide a unique system and method for communication of real estate property wherein a proprietary device may be configured by a real estate owner or agent to allow for transmittal of information to a buyer wherein the proprietary device may only transmit information relating to the property and the signal may not be intercepted and discarded for other uses such as general internet usage by others.

Another exemplary embodiment of the present invention is to provide a unique system and method for communication of real estate property wherein a proprietary device may be programmed to transmit information relating to a particular property and may be subsequently removed and reused after the property has sold.

Still another exemplary embodiment of the present invention is to provide a unique system and method for communication of real estate property wherein a proprietary device may be used that has internal storage capacity whereby information may be downloaded to the storage capacity by the owner/agent.

Yet another exemplary embodiment of the present invention is to provide a unique system and method for communication of real estate property wherein a proprietary device may be used wherein the device may be updated with a linkage system to transmit new or different information after initial programming by the owner/agent.

A further exemplary embodiment of the present invention is to provide a unique system and method for communication of real estate property wherein a proprietary device may be used to transmit information to a buyer and farther wherein the proprietary device may be updated remotely by the agent/owner offsite from the property.

Yet another exemplary embodiment of the present invention is to provide a unique system and method for communication of real estate property wherein the system uses a device to transmit information to potential buyers and further wherein the device may track data from potential buyers including the amount of times accessed, length of time, when the information was accessed and what other properties the buyer was interested in.

Still another exemplary embodiment of the present invention is to provide a unique system and method for communication of real estate property wherein the system uses a device to transmit information to potential buyers and further wherein the device may be contained within a structure on the property to transmit a signal to a wireless device outside of the structure.

Another exemplary embodiment of the present invention is to provide a unique system and method for communication of real estate property wherein the system may use a device which is light and portable such that it can be stored with relative ease.

Yet another exemplary embodiment of the present invention is to provide a unique system and method for communication of real estate property wherein the system uses a computer housing, a wi-fi card, memory and a cellular chipset to transmit data to a wireless device.

A further exemplary embodiment of the present invention is to provide a unique system and method for communication of real estate property wherein the system may use software to transmit the data relating to the property to a potential buyer.

Yet another exemplary embodiment of the present invention is to provide a unique system and method for communication of real estate property wherein a device is provided that may give a prospective buyer the chance to leave contact information.

Another exemplary embodiment of the present invention is to provide a unique system and method for communication of real estate property wherein a device is provided that may give a prospective buyer the chance to view a calendar of scheduled open houses.

Still another exemplary embodiment of the present invention is to provide a unique system and method for communication of real estate property wherein the system may employ a device which may notify an agent about a prospective property purchaser.

Yet another exemplary embodiment of the present invention is to provide a unique system and method for communication of real estate property wherein the system may employ a device which may notify an agent about a prospective property purchaser by sending the agent an e-mail, facsimile or other type of communication to the agent/owner.

Another exemplary embodiment of the present invention is to provide a unique system and method for communication of real estate property wherein the system may allow for removal and reuse of a device by an agent or owner when the property advertised is sold.

An exemplary embodiment of the present invention is to provide a unique system and method for communication of real estate property wherein the system may be synced to a portable device such as a laptop, Palm, and,or other device to download and/or upload information to and from the device.

Still another exemplary embodiment of the present invention is to provide a unique system and method for communication of real estate property wherein the system may utilize a LED indicator light on the box to display the status and usage of the box.

Another exemplary embodiment of the present invention is to provide a unique system and method for communication of real estate property wherein the system may utilize a display screen such as an LCD display screen on the device to display status and usage of the device and system.

Yet another exemplary embodiment of the present invention is to provide a unique system and method for communication of real estate property wherein the system may utilize a device inside the property wherein the device may remotely communicate with the owner/agent to provide information relating to a perspective buyer.

Still another exemplary embodiment of the present invention is to provide a unique system and method for communication of real estate property wherein the system may allow for multiple devices to be used wherein the devices would not interfere with one another because of the low range of signal strength from each box wherein the device may only transmit information within a certain geographical range of the property.

Another exemplary embodiment of the present invention is to provide a unique system and method for communication of real estate property wherein the system may allow for the device to be re-used multiple times after a property has been sold.

Still another exemplary embodiment of the present invention is to provide a unique system and method for communication of real estate property wherein the system may allow for communication of Multi-tenant property wherein the system and device may include all information relating to a plurality of inventory of the multi-tenant property.

Another exemplary embodiment of the present invention is to provide a unique system and method for communication of real estate property wherein the system may be utilized by a real estate office location wherein the system and device may include all inventory from that particular real estate office location.

Yet another exemplary embodiment of the present invention is to provide a unique system and method for communication of real estate property wherein the system may allow a non-web enabled device owned by a prospective buyer to communicate with the system by sending a text message to the box.

Still another exemplary embodiment of the present invention is to provide a unique system and method for communication of real estate property wherein the system may allow for communication with a SMS enabled device used by a prospective buyer.

Another exemplary embodiment of the present invention is to provide a unique system and method for communication of real estate property wherein the system may have blogging software located within the system for user comments and discussions about the properties or related neighborhoods.

These and other objects of the invention will become more clear when one reads the following specification, taken together with the drawings that are attached hereto. The scope of protection sought by the inventors may be gleaned from a fair reading of the Claims that conclude this specification.

Additional features and advantages of the present invention are described in, and will be apparent from, the detailed description of the presently preferred embodiments and from the drawings.

### BRIEF DESCRIPTION OF THE DRAWINGS

FIG. 1 is a flow chart overview of the system showing an exemplary embodiment of the invention;

FIG. 2 is a depiction of the device of the system in an exemplary embodiment of the present invention;

FIG. 3 is a flow chart showing a process in which a real estate property information is transmitted to a perspective buyer in an exemplary embodiment of the present invention;

FIG. 4 is a front view of a real estate sign in an exemplary embodiment of the present invention; and

FIG. 5 is frontal view of a portable communication device illustrating the information as viewed by a prospective buyer.

### DESCRIPTION OF THE PREFERRED EMBODIMENT

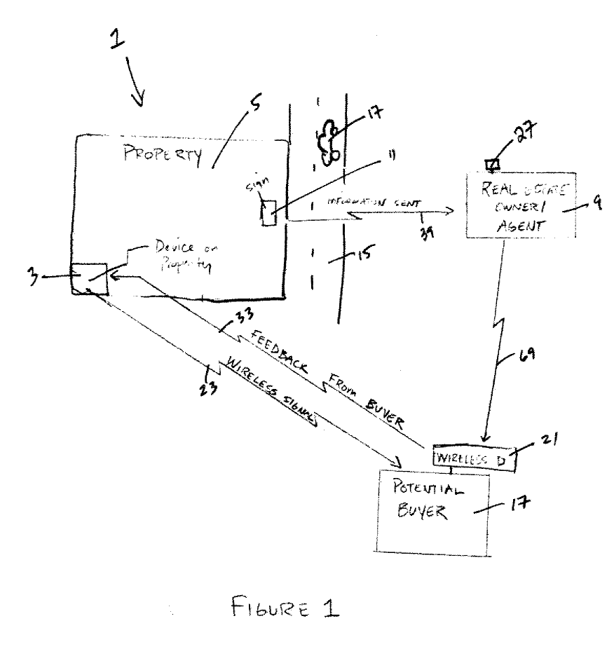

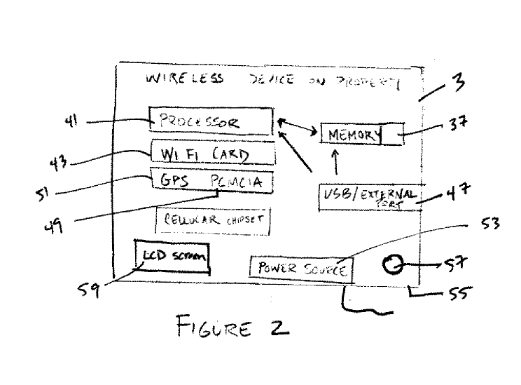

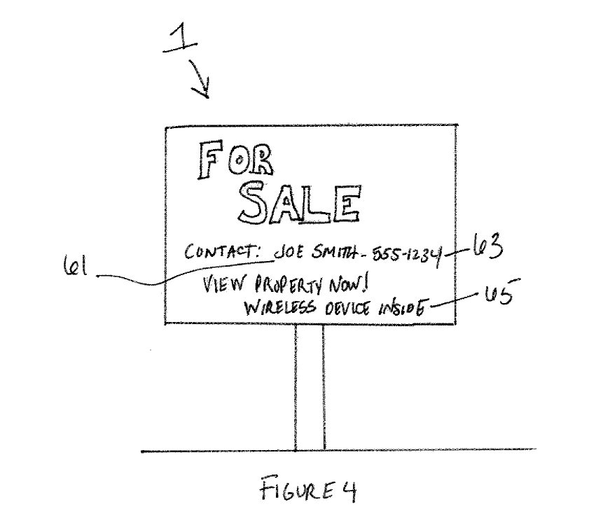

Turning now to the drawings wherein elements are identified by numbers and like elements are identified by like numbers throughout the 3 figures, the invention is depicted in FIG. 1 and shows an overview of the Real Estate advertising system 1 including the device 3 located on the property 5. The device 3 is further illustrated in FIG. 2. FIG. 1 illustrates a diagram showing the overall interactive real estate system 1 according to an exemplary embodiment of the present invention. As shown in FIG. 1, a property 5 is offered for sale by its owner (not shown). The owner (not shown) may contract with a real estate agent 9 or company to help in the process of selling the property 5. Typically, the real estate agent, company 9 or owner will advertise the sale of a property with some sort of physical sign 11 on the property. The sign 11 is usually displayed on the front portion 13 of the property 5 adjacent to a road or byway 15 where the sign 11 will be the most visible. A passerby or potential buyer 17 would be able to recognize that the particular piece of property 5 is currently for sale. Additionally, the sign 11 may have indicia thereon to indicate that this particular piece of property 5 has a wireless device 3 thereon to obtain additional information relating to the property 5 or structure on the property 5. A passerby or potential buyer 17 would be able to view the sign 11 from the outside of the property 5 and use a wireless device 21 in order to access information, description and pictures relating to the property 5 and/or structure on the property 5. In an exemplary embodiment of the present invention, a potential buyer 17 may be driving around a desired neighborhood looking for a suitable piece of property 5 to purchase. The buyer 17 would be able to recognize which properties are available by signs 11 placed on the property 5 that inform a potential buyer 17 that the selected properties 15 are for sale. However, very little information relating to the property 5 would be available from the sign 11. The potential buyer 17 would be notified by the sign 11 (as shown in FIG. 4) that the selected property 5 has a wireless device 3 located thereon and that the property 5 may be viewed by the buyer and or potential purchaser 17 by using their own handheld wireless device 21. In an embodiment, the handheld device 21 may be a Palm pilot, laptop, cellular device or any other contemplated handheld wireless device 21 capable of receiving and displaying the signal 23 transmitted by the wireless device 3 contained within the property 5. The wireless device 3 may be placed at any location on the property 5 to emit a wireless signal 23 that may be received and decoded by the handheld device 21 utilized by the prospective buyer 17. In an exemplary embodiment, the wireless device 3 may be contained within a structure on the property 5 including within a house, garage, shed, dog house or any other structure that may shelter the wireless device 3 from the elements. In an preferred embodiment, the wireless device 3 may be contained within a house on the property and may be plugged into an outlet of the house to supply the wireless device with a power source (not shown). Additionally, the device 3 may be located on the real estate office store front such that a prospective buyer 17 may view all the contents of the device 3 illustrating the entire inventory of that particular office or related offices. Moreover, the device box 3 may be used at a multi-tenant property such that a plurality of properties located at the same location may be viewed from a single device box 3.

As further illustrated in FIG. 1, the potential buyer 17 will receive a wireless signal 23 from the device 3 on the property 5. A sign 11 on the property 5 will inform a prospective buyer 17 of the presence of a wireless device 3. A prospective buyer 17 seeking to view the contents of the device from outside the property may use their own web enabled device 21 with wireless capability to connect to the wireless network named from the address of the property. This is a wireless network with speeds much faster than conventional broadband connections. This faster connection allows for much richer content such as full screen streaming video and audio, large graphic photographs of the interior and exterior and three hundred and sixty degree view tours. However, at no time may a prospective buyer 17 connect to the internet to view other websites. They system has a lockout system which allows a prospective buyer 17 to only view the instant home and pages related to the seller. The seller and/or home owner may dictate which pages and what information the prospective 17 buy may have access. This would eliminate the need for a general purpose wifi or traditional internet connection wherein a prospective buyer 17 or passerby may be able to obtain a general wireless internet signal and utilize the wireless connection or reasons other than the intended purpose.

The prospective buyer may download a digital flyer and/or brochure with details, data and other rich media content about the property. This same downloadable content may be copied to a USB key via a USB port (not shown) built in to the device 3. However, it should be understood that a plurality of different downloadable content may be copied to the device 3 by wireless connection 25 ad other types of access points. Additionally, an owner or real estate agent 9 may use the same USB port 47 or other download means to input additional information into the device 3 such as additional features of the property, price reductions, pending sales, and other information. The real estate agent 9 in an exemplary embodiment would simply use a portable memory device 27, connecting the portable memory device 27 to the device 3 and transmitting the information relating to the property 5 to the memory of the device 3.

A potential buyer 17 may have their own wireless device 21 including a palm pilot, PDA, laptop, cellular phone or a host of other wireless systems. The potential buyer 17 may see a sign 11 advertising the property 5 for sale. The potential buyer 17 could use their wireless device 21 to access a transmission 23 from the device 3 on the property 5. The device 3 on the property 5 may transmit a signal 23 that may be de-coded by the wireless device 21 and viewed by the potential buyer 17. The potential buyer 17 may be able to view pictures 29, take a virtual tour 31 of both the exterior of the property 5 and the interior of the property. Moreover, the system allows the potential buyer 17 to leave feedback 33 to the device 3 on the property 5. The feedback 33 may include such information as elements of the property 5 that they really like, things that the buyer think need improvement and the like. Moreover, the potential buyer 17 may leave their contact information 35 and/or request a scheduling of dates and times to view the property 5 with the agent and/or owner 9. This feedback information 33 is stored in the memory 37 of the device 3 and may be forwarded 39 to the real estate agent or owner 9. All of this information 39 may be sent in real time such that the device 3i will immediately send a transmission to the agent 9 relating to interest in the property 5. Whereby the agent 9 may contact the potential buyer 17 to schedule a viewing or to provide additional information relating to the property 5.

FIG. 2 illustrates the device 3 box that is located on the property 5 to transmit a signal 23 to prospective buyers 17. The device box 3 may be placed inside the property 5 for sale, and may contain a property specific web page (not shown) that can be accessed by consumers utilizing any wireless capable device 21 such as a phone, computer, PDA or other capable device. The device box 3 may have a USB port (not shown) contained thereon and/or an external port (not shown) that may allow information to be downloaded and/or uploaded to an external memory 39 capture device 3. This external port or USB port may be useful during open houses when the agent/owner 9 may want to provide prospective buyers 17 with a thumb drive unit to take home the information and read/print them on their own computer in the privacy of their own home. Additionally the external port or USB port 47 may provide the ability to download new information relating to the property 5 when desired by the agent/owner 9.

As further illustrated in FIG. 2, the device box 3 may further have a processor 41 to allow for processing of feedback information 33 from the potential buyer 17 and to perform statistical analysis of information such as the number of access times, the total time any given buyer may have accessed the device box and time of day in which the device box was accessed. The device box 3 may be a computer having a wireless card 43. The wireless card 43 allows for wireless connection of the device box 3 with external buyer 17 wireless capable devices 21 that may sync up to the device box 3 and download and de-code information from the device box 3. In an exemplary embodiment, the device box 3 may also have a Compact Flash solid state memory 37. This memory 37 allows for downloads of information and capturing of data that may be transmitted to the agent/owner 9 of the property 5. Additionally the device box 3 may have a PCMCIA card 49 that allows for cellular network connection. Moreover, the PCMCIA card 49 may have built in GPS 51 capabilities that may allow the device 3 to upload its location to an agent's site 9. This allows a prospective buyer 17 to view the location of all the agent's inventories featuring device boxes 3 on those properties 5. This information may be posted to an agent's website and viewable from anywhere. The GPS capabilities 51 may also allow for the prospective buyer 17 to get exact information on other properties in the area and may allow for the device box 3 to give directions to other locations having the device boxes 3 on those respective properties.

FIG. 2 further illustrates a device box 3 that may have a power source 53 internally housed therein. In an exemplary embodiment, the power source 53 may be a battery contained within the housing 55 of the device box 3. However, in another exemplary embodiment, the power source 53 may be external wherein the device box 3 may be plugged into an outlet contained on the property 5 such that no internal power source 53 is needed. Additionally, the device box 3 may have an LED indicator 57 light that may display the status and usage of the box 3. In another embodiment, the device box 3 may also have an LCD type display screen 59 which may be utilized to display information about the device 3, status and usage information.

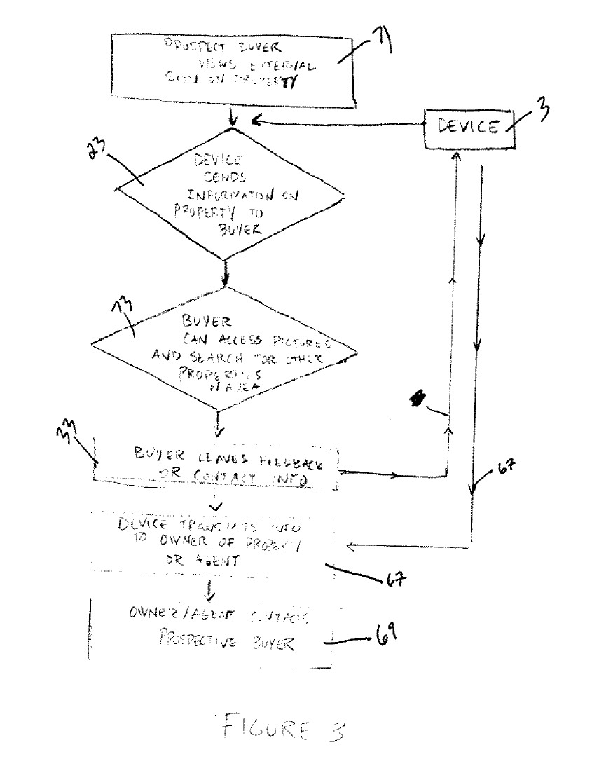

FIG. 3 illustrates a flow chart of the real estate advertising system 1 in practice. The first step in the process may be where a prospective buyer 17 views 71 the external sign 11 on the property 5 illustrated in FIG. 4. The sign 11 as shown in FIG. 4 informs the prospective buyer 17 of the Contact person 61 and associated phone number 63 and informs that the property 5 is for sale. Additionally, the sign 11 may present information 65 relating to the fact that the property has a device box 3 located thereon and that the prospective buyer 17 may be able to access more information relating to this property 5 and others by using their own wireless capable device 21. The device box 3 located on the property 5 may then send information 23 relating to the property 5 to the wireless capable device 21 used by the prospective buyer such as a PDA, laptop, cellular phone or other device. However, it should be understood that the prospective buyer 17 may not have a wireless enable device 21. In this event, the buyer may send a text message to the box 3 in order to communicate interest or other information relating to the property 5. It should be further understood that a plurality of other communication methods are available that do not require web-enabled devices in order to communicate with the device 3. The buyer 17 may access information 73 such as pictures 29, virtual tours 31 and may be able to generate a portable document file that is downloaded from the device box located on the property. Additionally, the prospective buyer 17 may be able to leave feedback information 33, request a showing or find other properties located in the same area or similar to the property 5 being viewed. Moreover, each household may have a blog or other online comment book that allows for comments and dialogues about the property. The device 3 may have blogging software located within he device 3 for user comments 33 and discussions about the property 5. The text and pictures 29 located on each device 3 may be customized by the agent 9 for each property 5 by uploading the text and pictures 29 from their own computer onto the device box 3.

The device box 3 may collect information that will be stored in the memory 37 of the device box 3 for subsequent distribution 67 (fax/e-mail) to the agent 9. The device box 3 may collect information relating to a prospective buyer 17 interested in the property 5 and may transmit the information 67 to the owner of the property or the agent 9. The owner/agent 9 may then contact 69 the prospective buyer 17 to provide additional information or to set up a scheduled viewing of the property 5.

As illustrated in FIG. 4, a prospective buyer 17 would be able to determine if the property 5 had a device box 3 located thereon as the sign 11 would disclose the same. The sign 11 could be like conventional, traditional prior art sale signs 11 which give information relating to contact 61 and property 5 but might also include information informing the prospective buyer 17 that they may view the property from their wireless device 21 any time they like.

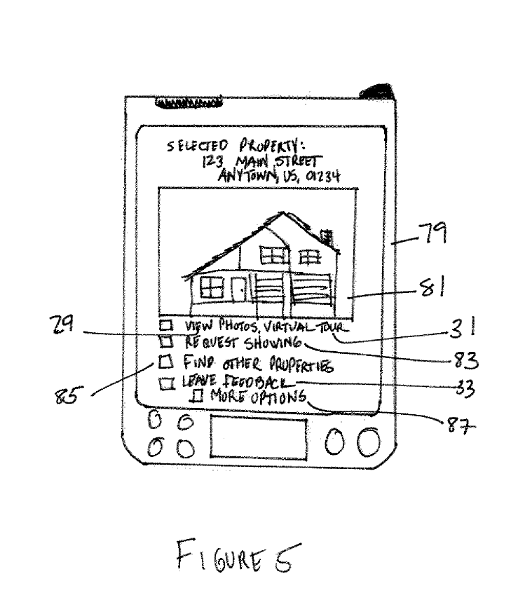

FIG. 5 illustrates a frontal view of a depiction of what a prospective buyer 17 will be able to access from the device box 3 located on the property 5. A prospective buyer 17 would receive a wireless signal 23 from the device box 3 which may contain a plurality of options for the buyer 17. In the present exemplary embodiment, FIG. 5 illustrates a PDA 79 of a prospective buyer 17. It should be understood that a plurality of different wireless capable devices 21 may be used and may show similar displays as that depicted in FIG. 5. A selected property 5 may be viewed by the prospective buyer 17 wherein the device box 3 contains property specific web pages that can be accessed by consumers. A prospective buyer 17 may view a general photograph 81 of the property as illustrated in FIG. 5. Additionally, the buyer may be prompted to select from a list that allows them to view additional photographs 29 and take a virtual tour 31. Moreover, the buyer may be prompted to leave feedback information 33 or request a showing 83 of the property 5. Further, if the buyer is not interested in that particular property 5 or would like to see similar properties, the buyer 17 may be prompted to select a feature 85 wherein they may view other properties and may be given directions to those properties. An additional element allows a prospective buyer 17 to select from additional options 87 that may allow them to leave comments, participate in a dialogue or blog group or a host of other options. Additionally, the more options selection 87 may give the buyer information relating to the owner, tax area, agent and a plurality of additional information.

While the invention has been described with reference to a particular embodiment thereof, those skilled in the art will be able to make various modifications to the described embodiment of the invention without departing from the true spirit and scope thereof. It is intended that all combinations of elements and steps which perform substantially the same function in substantially the same way to achieve substantially the same result are within the scope of this invention.

What is claimed is:

1. A real estate system comprising:
a real estate sign corresponding to a property wherein the real estate sign displays that the property has a wireless communication system thereon;
a wireless electronic device having property information contained thereon; and
the device being contained within a structure on the property.

2. The real estate system of claim 1, wherein the wireless electronic device transmits a signal to a potential buyer's wireless capable electronic device.

3. The real estate system of claim 1 wherein the wireless electronic device transmits information relating to the property including photographs and virtual tours of the property.

4. The real estate system of claim 1 wherein the wireless electronic device transmits information relating to the property including information about the agent and other properties available for sale.

5. The real estate system of claim 1 wherein the wireless electronic device further comprises a processor and a memory storage unit.

6. The real estate system of claim 1 wherein the wireless electronic device further comprises a power source, wireless networking capability and a Global Positioning system.

7. The real estate system of claim 1 wherein information may be stored and removed from the wireless electronic device when desired.

8. The real estate system of claim 1 wherein a potential buyer may leave feedback information that is inputted into the memory storage unit of the wireless electronic device.

9. The real estate system of claim 1 wherein the wireless electronic device notifies an owner or agent of potential buyers of the property if feedback information is left by the potential buyer with the wireless electronic device.

10. The real estate system of claim 1 wherein the wireless electronic device transmits a property specific web page that cannot be utilized for any other purpose other than the transmittal of that specific property or linked properties contained within the memory of the wireless electronic device.

11. A method for using a real estate resource system the method comprising the steps of:
providing a real estate sign corresponding to a property wherein the real estate sign displays that the property has a wireless communication system thereon;
providing a wireless electronic device having property information contained thereon wherein the device is contained within a structure on the property;
inputting information into the wireless electronic device relating to the property for transmission to potential purchasers.

12. The method of claim 11, further comprising the step of:
providing the wireless electronic device with wireless networking capability.

13. The method of claim 11 further comprising the step of:
providing the wireless electronic device with a processor and memory storage capabilities.

14. The method of claim 11 further comprising the step of:
providing the wireless electronic device with a power source and Global positioning capabilities.

15. The method of claim 11 further comprising the step of;
allowing the wireless electronic device to transmit a web-based property specific web page to a potential buyer.

16. The method of claim 11, further comprising the step of:
allowing a potential purchaser with a wireless capable device to receive a transmission from the wireless electronic device located on the property.

17. The method of claim 11, further comprising the step of:
prompting the potential purchaser to leave feedback relating to the property.

18. The method of claim 1, farther comprising the step of:
prompting the potential purchaser to request a showing of the property or to contact the agent or owner of the property.

19. The method of claim 11 further comprising the step of:
transmitting the contact information of a potential purchaser to the agent or owner such that the agent or owner can contact the potential purchaser to provide additional information or schedule a viewing of the property.

20. The method of claim 11 further comprising the step of:
allowing for the wireless electronic device to be removed from the property and the information on the memory of the device to be removed and replaced with new information relating to a new property.
